(19) United States
(12) Patent Application Publication
(10) Pub. No.: US 2026/0159004 A1
(43) Pub. Date: Jun. 11, 2026

(54) AUTOMATED ROOF RACK

(71) Applicant: Avraham Y. Levi, Eagan, MN (US)

(72) Inventor: Avraham Y. Levi, Eagan, MN (US)

(21) Appl. No.: 19/413,922

(22) Filed: Dec. 9, 2025

Related U.S. Application Data
(60) Provisional application No. 63/730,356, filed on Dec. 10, 2024.

(51) Int. Cl. B60R 9/042; B60P 7/08

(52) U.S. Cl. CPC B60R 9/042; B60P 7/0823

(57) ABSTRACT

An automated vehicle roof rack including a driven hoist assembly connected to a slave hoist assembly by a drive shaft. Each hoist assembly has a vehicle attachment assembly and a three-stage slide. The drive assembly of the driven hoist assembly in combination with a gas spring is operable to position the three stage slide horizontally. The slide then folds to a vertical position where the three stage slide extends to its full length. In this extended position, equipment can be attached and detached from the slide. When desired to transport the equipment, the drive assembly can be activated to hoist the equipment back onto the vehicle roof.

### RELATED APPLICATIONS

The present application claims the benefit of U.S. Provisional Application No. 63/730,356 entitled AUTOMATED ROOF RACK, and filed Dec. 10, 2024, said application being hereby fully incorporated herein in its entirety by reference.

### TECHNICAL FIELD

The invention is related to vehicle mounted racks, and more specifically, racks for attaching work accessories such as ladders to a vehicle.

### BACKGROUND

Equipment such as ladders is often needed when performing construction and maintenance work, and in providing emergency services such as firefighting. It is often necessary to transport such equipment using a vehicle, and due to the size of the equipment, it is necessary to attach the equipment to the top of the vehicle. Roof racks installable on the top of a van or box truck have been developed and are in common use for such purposes.

A problem is presented, however, in accessing the top of the vehicle to attach the equipment to the rack. Climbing the truck for this purpose presents a safety hazard and, in some jurisdictions, is even prohibited for public employees.

What is needed in the industry is a vehicle rack for equipment such as ladders where the equipment can be accessed from ground level, while still enabling the equipment to be stowed on the vehicle roof.

### SUMMARY

The present inventions address the need in the industry for a vehicle rack for equipment such as ladders where the equipment can be accessed from ground level, while still enabling the equipment to be stowed on the vehicle roof. According to embodiments of the inventions disclosed herein, an automated vehicle roof rack includes a driven hoist assembly connected to a slave hoist assembly by a drive shaft. Each hoist assembly has a vehicle attachment assembly and a three-stage slide driven by a drive assembly. The drive assembly in combination with a gas spring is operable to position the three stage slide horizontally. The slide then folds to a vertical position where the three stage slide extends to its full length. In this extended position, equipment can be attached and detached from the slide. When desired to transport the equipment, the drive assembly can be activated to hoist the equipment back onto the vehicle roof.

The automated vehicle roof rack can have various features enabling ease of use and safety, such as an electro-mechanical latch to lock the slide in the stowed position, a slide rest for locating and securing the slide, a limit for deactivating the motor of the drive assembly when the slide is fully retracted, and a stabilizer for stabilizing the slide when in the vertical position. A slide folding mechanism can be provided for properly folding the stabilizer when the slide is retracted.

According to embodiments, a motorized storage rack adapted to attach to a roof of a vehicle includes a pair of spaced-apart hoist assemblies. Each hoist assembly includes a vehicle attachment assembly including an elongate base member adapted to attach to the vehicle, and a slide guide member operably coupled to the base member, a slide assembly including a plurality of slide stage members, the slide assembly operably coupled to and slidably shiftable on the slide guide member, each one of the plurality of slide stage members presenting a length dimension and being operably coupled to an adjacent one of the plurality of slide stage members so as to be shiftable along the length of the adjacent one of the plurality of slide stage members so that the slide assembly is selectively extendable and retractable between a retracted position in which the slide assembly presents a first length dimension and an extended position in which the slide assembly presents a second length dimension greater than the first length dimension, and a gas spring. The rack further includes a pair of spool assemblies, each one of the pair of spool assemblies operably coupled to a separate one of the hoist assemblies and including a rotatable spool and a strap wound on the spool, the strap operably coupled with each one of the plurality of slide stage members and the gas spring, wherein the gas spring is arranged to bias the slide assembly toward the extended position by applying tension to the strap, the strap coupled to the slide stage members so as to enable progressive extension or retraction of the slide assembly depending on a direction of rotation of the spool. A drive shaft rotatably couples the spools of the pair of spool assemblies together, and a drive assembly is operably coupled to the spool of one of the spool assemblies and selectively operable to rotate the spool.

In embodiments, the drive assembly includes an electric motor and a reduction gear box. The slide guide member can be coupled to the base member with a hinge enabling the slide guide member to be shifted between a folded position in which the slide guide member is generally parallel to the elongate base member, and an unfolded position in which the slide guide member is generally perpendicular to the elongate base member.

In embodiments, the rack includes an articulating stabilizer operably coupling the slide guide member and the base member. A gas cylinder can be arranged to bias the hinge toward the unfolded position.

In embodiments, each slide assembly has three slide stage members. The three slide stage members can include a first slide stage member, a second slide stage member, and a third slide stage member, the first slide stage member being slidably engaged with the slide guide member, the second slide stage member being slidably engaged with the first slide stage member, and the third slide stage member being slidably engaged with the second slide stage member. An uppermost one of the plurality of slide stage members presents a top surface, and the top surface can have a flexible track adapted for attaching a ladder.

In an embodiment, the gas spring has a stroke length and the gas spring and the slide stage members are coupled with the strap so that the slide stage members shift a distance of two times the stroke length when the gas spring extends.

In further embodiments, a motorized rack for temporarily attaching equipment to a vehicle includes at least one hoist assembly. The hoist assembly includes a vehicle attachment assembly including an elongate base member adapted to attach to the vehicle, and a slide guide member operably coupled to the base member with a hinge such that the slide guide member is shiftable between a folded position and an unfolded position. The vehicle attachment assembly further includes a first gas spring arranged to bias the slide guide member toward the unfolded position. The hoist assembly further includes a slide assembly with a plurality of slide stage members coupled together, the slide assembly being selectively extendable and retractable between a retracted position presenting a first length dimension and an extended position presenting a second length dimension, the second length dimension greater than the first length dimension, the slide assembly being shiftable on the slide guide member, and a second gas spring. A spool assembly is operably coupled to the at least one hoist assembly, the spool assembly including a rotatable spool and a strap wound on the spool, the strap operably coupled with each one of the plurality of slide stage members and the second gas spring, wherein the second gas spring is arranged to bias the slide assembly toward the extended position by applying tension to the strap, the strap coupled to the slide stages so as to enable progressive extension or retraction of the slide assembly depending on a direction of rotation of the spool. A drive assembly is operably coupled to the spool and is selectively operable to rotate the spool.

In embodiments, the drive assembly comprises an electric motor and a reduction gear box. The motorized rack can further include an articulating stabilizer operably coupling the slide guide member and the base member.

In embodiments, the slide assembly has three slide stage members. The three slide stage members can include a first slide stage member, a second slide stage member, and a third slide stage member, the first slide stage member being slidably engaged with the slide guide member, the second slide stage member being slidably engaged with the first slide stage member, and the third slide stage member being slidably engaged with the second slide stage member. An uppermost one of the plurality of slide stage members presents a top surface, and the top surface can have a flexible track adapted for attaching the equipment.

In embodiments, the second gas spring has a stroke length and the second gas spring and the slide stage members are coupled with the strap so that the slide stage members shift a distance of two times the stroke length when the second gas spring extends.

In embodiments, the motorized rack includes a second hoist assembly and a second spool assembly, the second spool assembly being coupled to the first spool assembly with a drive shaft.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

The subject matter hereof may be more completely understood in consideration of the following detailed description of various embodiments in connection with the accompanying figures, in which:

FIG. 1 is an isometric view of an automated roof rack according to embodiments of the invention;

FIG. 2 is an isometric view the automated roof rack of FIG. 1 with ladders attached and the automated roof rack in a stowed position;

FIG. 3 is an isometric view the automated roof rack of FIG. 1 with ladders attached and the automated roof rack in a deployed position;

FIG. 4 is an isometric view of the driven hoist assembly of the automated roof rack of FIG. 1;

FIG. 5 is an isometric view of the base member and slide guide of the driven hoist assembly of FIG. 4 in a stowed position;

FIG. 6 is a partial isometric view of the base member and slide guide of the driven hoist assembly of FIG. 4 in a deployed position;

FIG. 6A is another partial isometric view of the base member and slide guide member of the driven hoist assembly of FIG. 4 in a deployed position;

FIG. 7 is an isometric view of the slide guide of the driven hoist assembly of FIG. 4;

FIG. 8 is a top isometric view of the slide assembly of the driven hoist assembly of FIG. 4;

FIG. 9 is a bottom isometric view of the slide assembly of the driven hoist assembly of FIG. 4;

FIG. 10 is a partial exploded view of the slide assembly of the driven hoist assembly of FIG. 4;

FIG. 11 is a cross-sectional view of the driven hoist assembly of FIG. 4 taken at section 11-11 of FIG. 4;

FIG. 11A is an end elevation view of the first stage slide of the driven hoist assembly of FIG. 4;

FIG. 11B is an end elevation view of the second stage slide of the driven hoist assembly of FIG. 4;

FIG. 11C is an end elevation view of the third stage slide of the driven hoist assembly of FIG. 4;

FIG. 12A is a partial isometric view of the proximal end of the slide assembly of the driven hoist assembly of FIG. 4;

FIG. 12B is another partial isometric view of the proximal end of the slide assembly of the driven hoist assembly of FIG. 4;

FIG. 13 an isometric view of the drive assembly of the driven hoist assembly of FIG. 4;

FIG. 14 is another isometric view of the drive assembly of the driven hoist assembly of FIG. 4;

FIG. 15 is a right isometric view of the spool assembly of the driven hoist assembly of FIG. 4;

FIG. 16 is a left isometric view of the spool assembly of the driven hoist assembly of FIG. 4;

FIG. 17 is a left isometric view of the spool assembly of the driven hoist assembly of FIG. 4 with the housing shown as transparent to enable viewing of internal components;

FIG. 18 is a right isometric view of the spool assembly of the driven hoist assembly of FIG. 4 with the housing shown as transparent to enable viewing of internal components;

FIG. 19 is an isometric view of a tension plate of the spool assembly of FIGS. 15-18;

FIG. 20 is a partial isometric view of the driven hoist assembly of FIG. 4 with the spool assembly housing shown as transparent to enable viewing of internal components;

FIG. 21 is a partial isometric view of the driven hoist assembly of FIG. 4;

FIG. 22 is a partial isometric view of the drive assembly and latch of the driven hoist assembly of FIG. 4;

FIG. 23 is a partial cross-sectional view of the driven hoist assembly of FIG. 4 taken at section 23-23 of FIG. 4;

FIG. 24 is a partial isometric view of the driven hoist assembly of FIG. 4 in a deployed position;

FIG. 25 is a partial isometric view of the folding mechanism of the driven hoist assembly of FIG. 4 with the spring loaded arm extended;

FIG. 26 is a partial isometric view of the folding mechanism of the driven hoist assembly of FIG. 4 with the spring loaded arm depressed;

FIG. 27 is a cross sectional view of the driven hoist assembly of FIG. 4 taken at section 27-27 of FIG. 4;

FIG. 28 is a side elevation view of the driven hoist assembly of FIG. 4; and

FIG. 29 is an isometric view of the slave hoist assembly of the automated roof rack of FIG. 1.

While various embodiments are amenable to various modifications and alternative forms, specifics thereof have been shown by way of example in the drawings and will be described in detail. It should be understood, however, that the intention is not to limit the claimed inventions to the embodiments described. On the contrary, the intention is to cover all modifications, equivalents, and alternatives falling within the spirit and scope of the subject matter as defined by the claims.

### DETAILED DESCRIPTION OF THE DRAWINGS

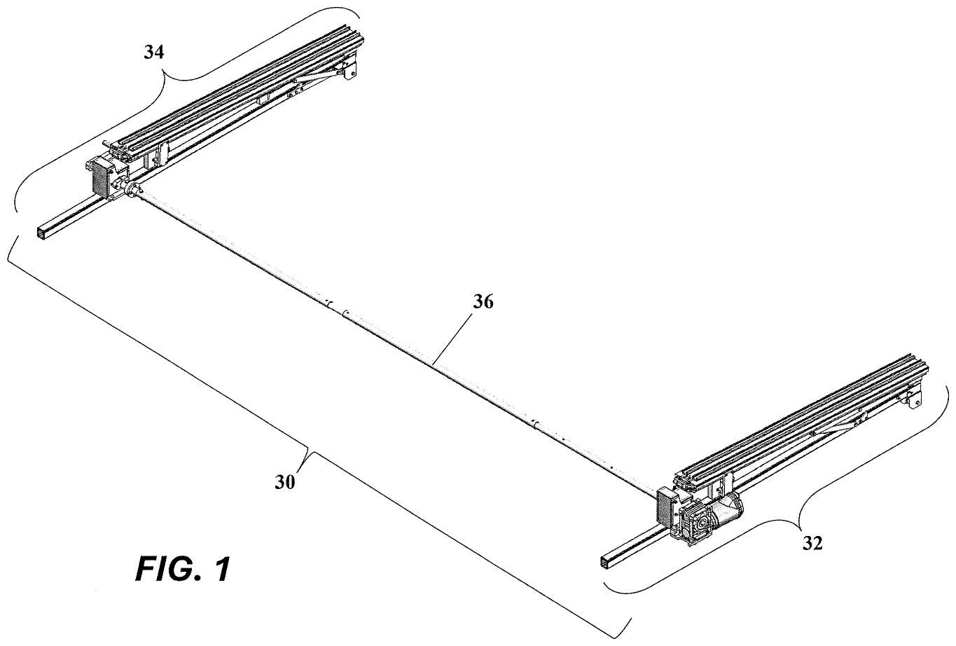

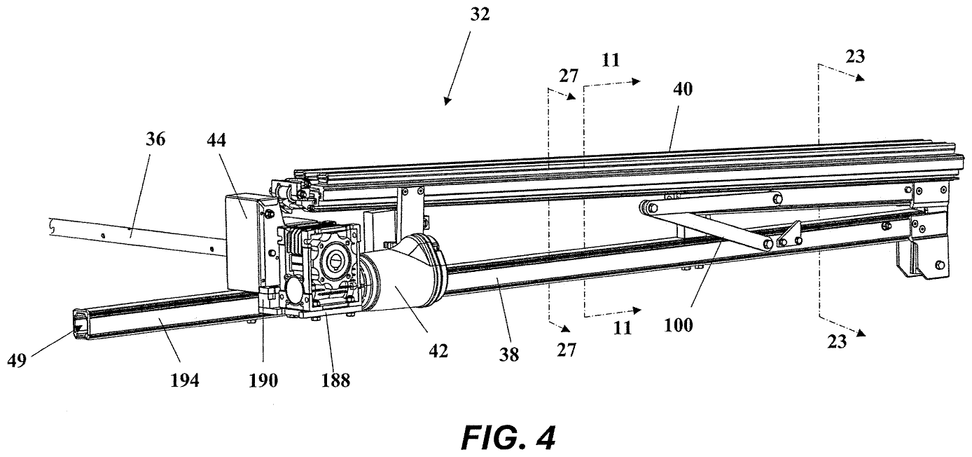

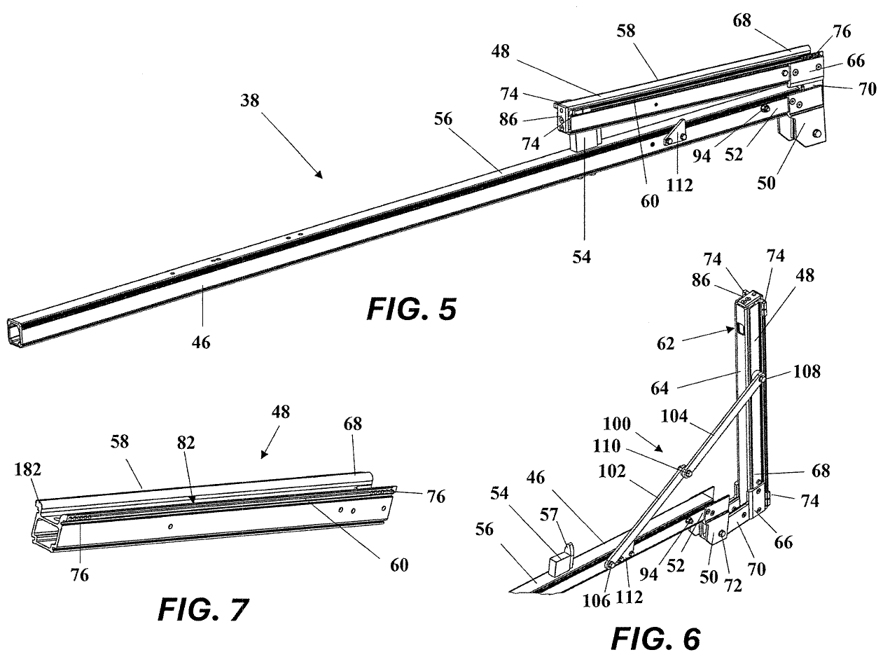

As depicted in FIG. 1, automated roof rack 30 generally includes driven hoist assembly 32, slave hoist assembly 34, and drive shaft 36. As depicted in FIG. 4, driven hoist assembly 32 generally includes vehicle attachment assembly 38, slide assembly 40, drive assembly 42, and spool assembly 44. Vehicle attachment assembly 38 is depicted in FIGS. 5-7, and generally includes base member 46 and slide guide 48. Base member 46 is a hollow tube defining interior space 49 and has downwardly projecting hinge member 50 at distal end 52. Slide rest 54 is provided on upper side 56 and has aligning member 57.

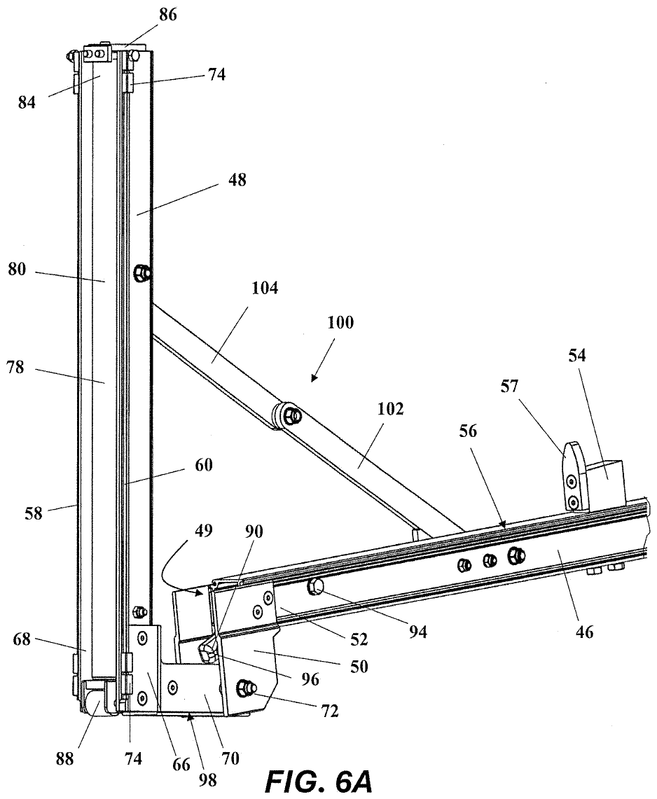

Slide guide 48 has laterally projecting slide shoulders 58, 60, and defines locating aperture 62 in bottom side 64. Hinge member 66 is coupled to slide guide 48 at distal end 68, and has extension portion 70. Extension portion 70 is pivotally coupled to hinge member 50 with bolt 72 so that slide guide 48 is pivotable with respect to base member 46 about bolt 72 between a folded position as depicted in FIG. 5 in which slide guide 48 is generally parallel to base member 46, and an unfolded position as depicted in FIGS. 6 and 6A, in which slide guide 48 is generally perpendicular to base member 46. Slide bearings 74 are received on receiving pins 76 defined in slide shoulders 58, 60. Slide extension gas spring 78 generally includes cylinder 80 enclosing plunger rod (not depicted), which is biased longitudinally outward by gas pressure inside cylinder 80. Gas spring 78 is received between slide shoulders 58, 60, on top side 82 of slide guide 48. Proximal end 84 of cylinder 80 is affixed to spring mount 86, and plunger rod (not depicted) carries roller 88. Tilt gas spring 90 is disposed inside interior space 49 of base member 46 and proximal end 92 is pivotally attached to base member 46 at pivot bolt 94. Distal end 96 bears against end wall 98 of extension portion 70 when slide guide 48 is in the folded position, biasing slide guide 48 toward the unfolded position.

Articulating stabilizer 100 generally includes lower arm 102 and upper arm 104. Lower arm 102 is pivotally connected to base member 46 with pivot bolt 106, and upper arm 104 is pivotally connected to slide guide 48 with pivot bolt 108. Lower arm 102 and upper arm 104 are pivotally coupled at pivot 110. Arm rest 112 is provided on base member 46, providing a fixed stop for lower arm 102, and positioning articulating stabilizer 100 slightly over-center when extended.

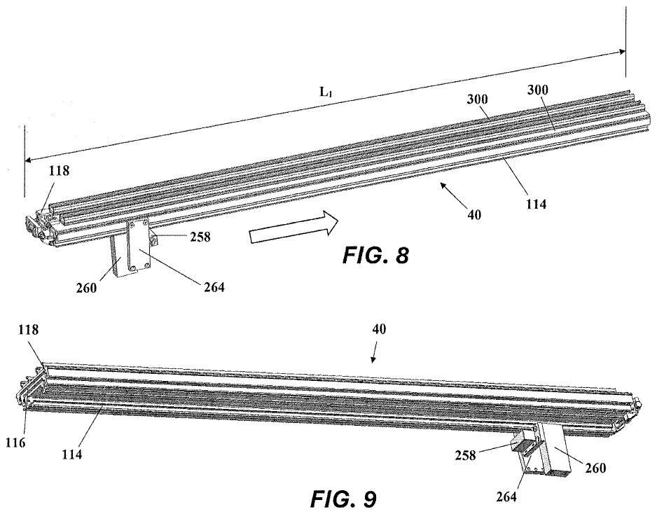

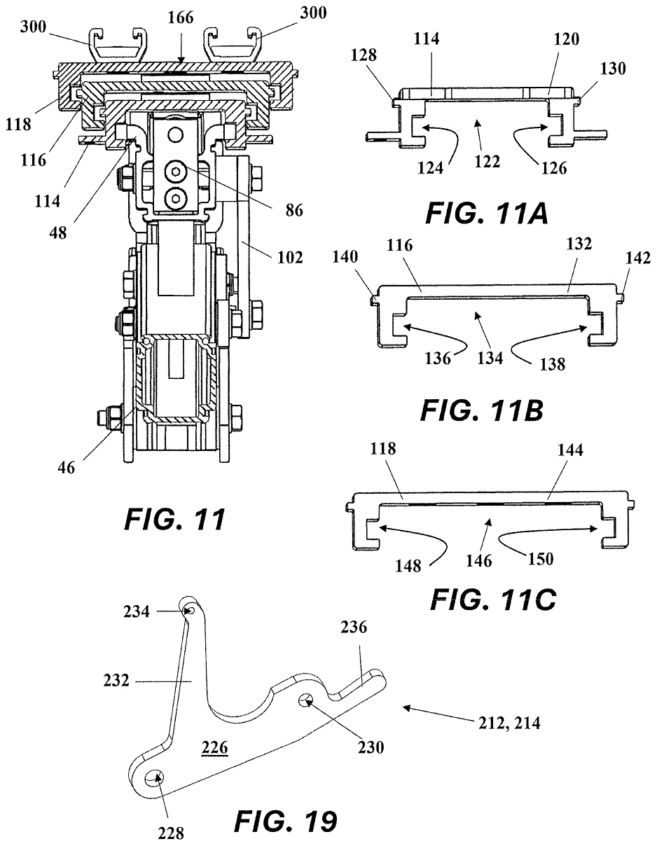

Slide assembly 40 is depicted in FIGS. 8-12B, and generally includes first stage slide member 114, second stage slide member 116, and third stage slide member 118. First stage slide member 114 has elongate body 120 presenting downwardly facing recess 122. Opposing slide recesses 124, 126, are defined facing into recess 122. Slide shoulders 58, 60, with slide bearings 74 of slide guide 48 are slidably received in opposing slide recesses 124, 126, respectively. Elongate body 120 defines slide shoulders 128, 130.

Second stage slide member 116 has elongate body 132 presenting downwardly facing recess 134. Opposing slide recesses 136, 138, are defined facing into recess 134. Slide shoulders 128, 130, of first stage slide member 114, which may have slide bearings 139, are slidably received in opposing slide recesses 136, 138, respectively. Elongate body 132 defines slide shoulders 140, 142.

Third stage slide member 118 has elongate body 144 presenting downwardly facing recess 146. Opposing slide recesses 148, 150, are defined facing into recess 146. Slide shoulders 140, 142, of second stage slide member 116, which may have slide bearings 151, are slidably received in opposing slide recesses 148, 150, respectively.

Although the slide members 114, 116, 118, and slide guide 48 are depicted here as being in sliding connection with each other, it will be appreciated that rollers could be used to establish a rolling connection between any or all of these components to reduce friction.

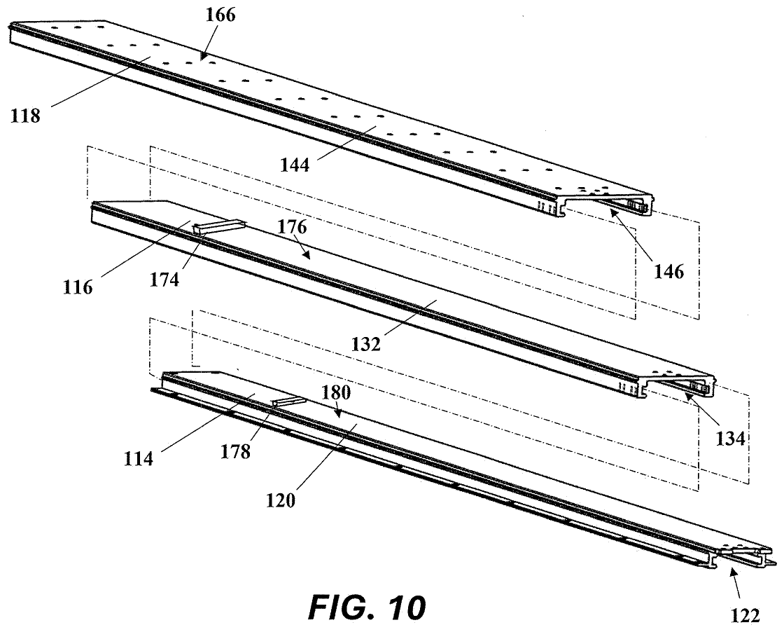

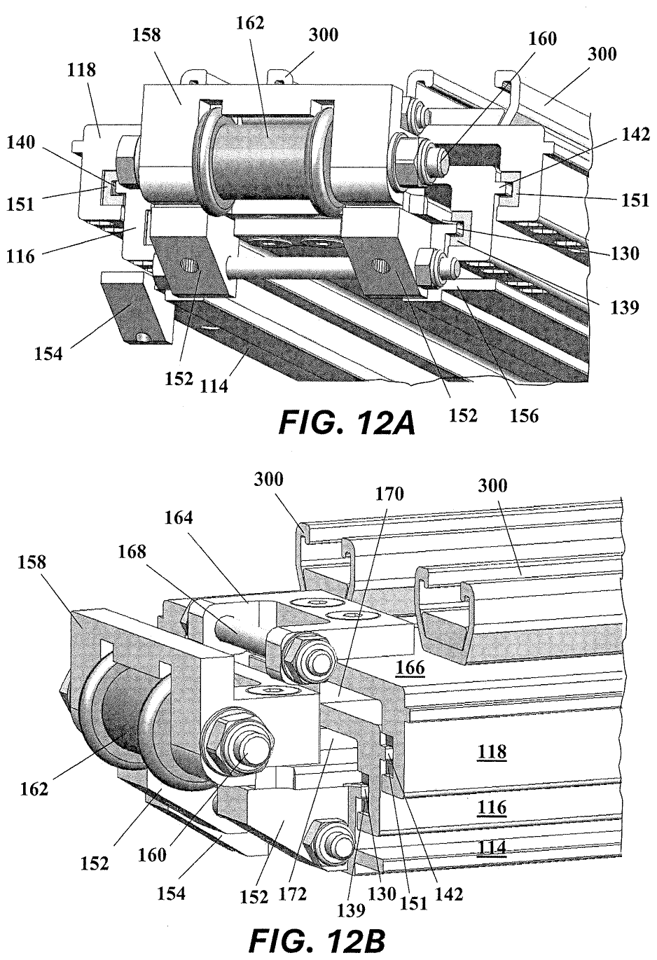

As depicted in FIGS. 12A and 12B, stop blocks 152 and limit ramp 154 are affixed to the underside at proximal end 156 of first stage slide member 114 Roller bracket 158 is affixed to the top side of first stage slide member 114 at proximal end 156, and carries axle 160 which rotatably mounts belt roller 162. Attachment bracket 164 is affixed to top side 166 of third stage slide member 118, and carries strap attachment pin 168. Stop block 170 is affixed to the underside of third stage slide member 118, and stop block 172 is affixed to the underside of second stage slide member 116. As depicted in FIG. 10, stop block 174 is affixed to top side 176 of second stage slide member 116 and stop block 178 is affixed to top side 180 of first stage slide member 114.

Flexible tracks 300 can be attached to top side 166 of third stage slide member 118 to enable in use attachment of the items to be carried on automated roof rack 30.

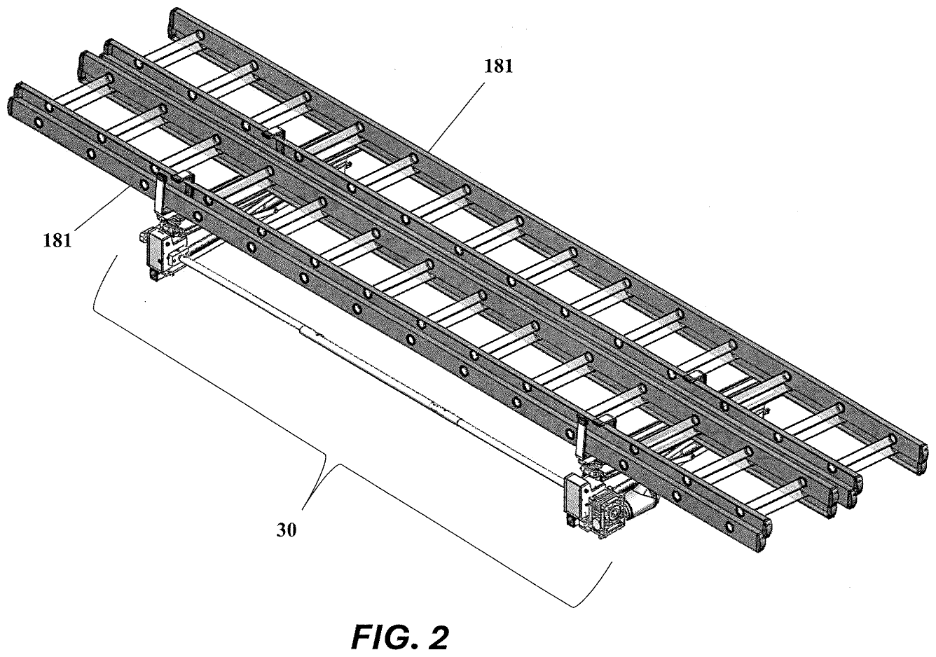

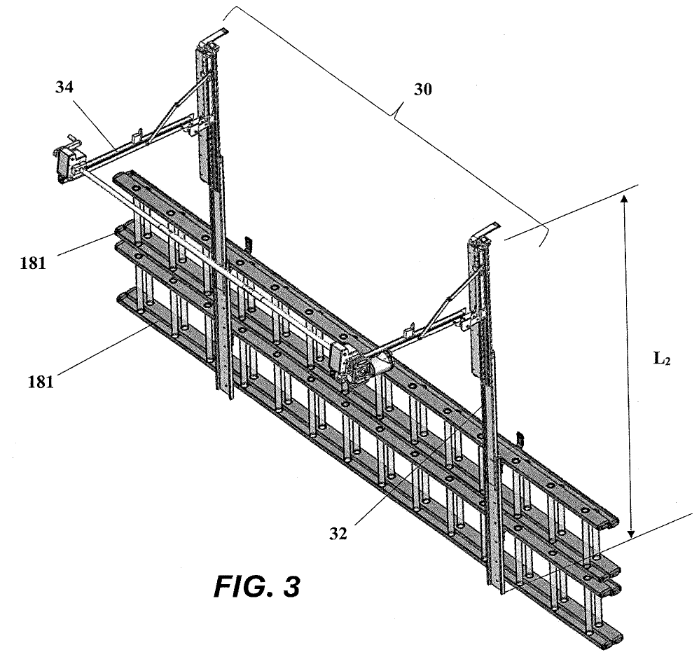

It will be appreciated that, from the position depicted in FIG. 8, first stage slide member 114, second stage slide member 116, and third stage slide member 118 can be slid in the direction of the arrow. First stage slide member 114 will slide over slide guide 48 until stop blocks 152 contact proximal end 182 of slide guide 48, second stage slide member 116 will slide over first stage slide member 114 until stop block 172 contacts stop block 178, and third stage slide member 118 will slide until stop block 170 contacts stop block 174. Hence, the overall length of slide assembly 40 can increase from a retracted length L₁ as depicted in FIG. 8 to an extended length L₂ as depicted in FIG. 3. The lengths of first stage slide member 114, second stage slide member 116, and third stage slide member 118 can be selected so that lengths L₁ and L₂ are suitable for attaching and presenting the intended items, such as ladders 181 as depicted in FIGS. 2 and 3.

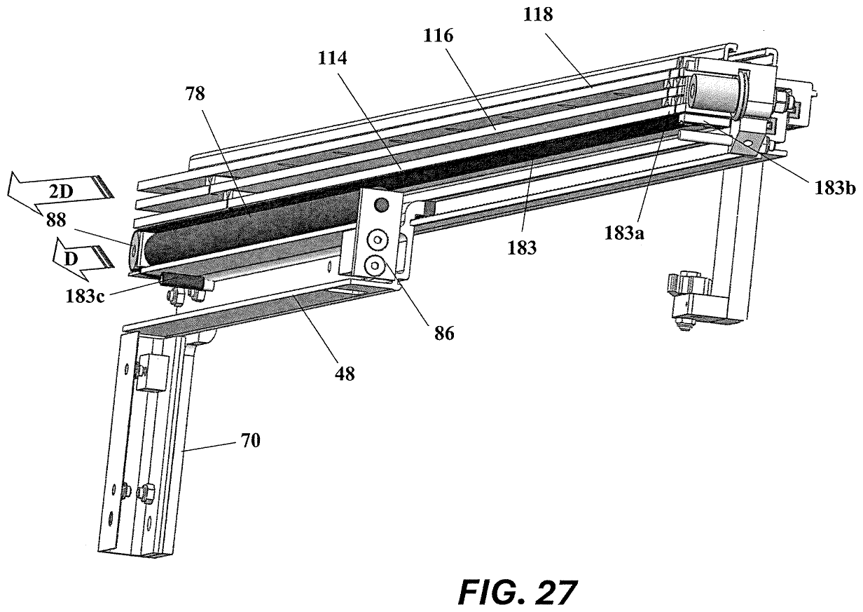

The configuration and function of gas spring 78 is illustrated in the cross-sectional view of FIG. 27. Strap 183 is attached at one end to proximal end 183a of first stage slide member 114 with clamp 183b. Strap 183 loops over roller 88, and the opposite end is attached to post 183c inside slide guide 48. Gas spring 78 applies a biasing force to strap 183, tending to urge first stage slide member 114 in the direction of the arrow. It will be appreciated that if the gas spring stroke is a distance D₁, first stage slide member 114, second stage slide member 116, and third stage slide member 118, will advance a distance D₂ that is twice D₁.

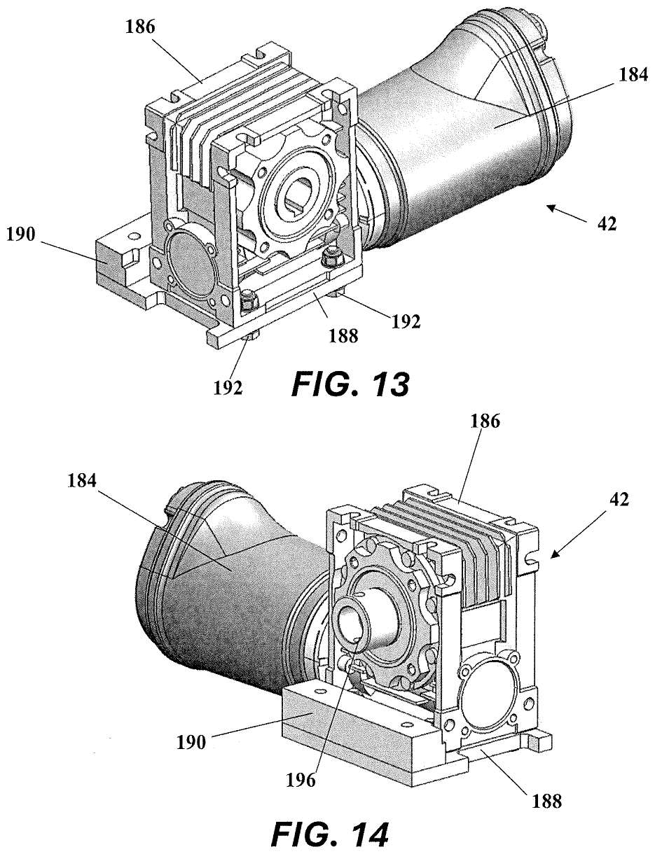

Drive assembly 42, as depicted in FIGS. 13 and 14, generally includes electric motor 184, reduction gear box 186, base plate 188, and spacer block 190. Reduction gear box 186 is secured to base plate 188 with bolts 192 and spacer block 190 is secured to base plate 188 and side 194 of base member 46 as depicted in FIG. 4. Adapter 196 is provided on the output of reduction gear box 186 to enable connection with spool assembly 44 as will be described below. It will be appreciated that any commercially available gear-motor assembly that provides an output having a suitable revolution speed can be substituted for electric motor 184 and reduction gear box 186.

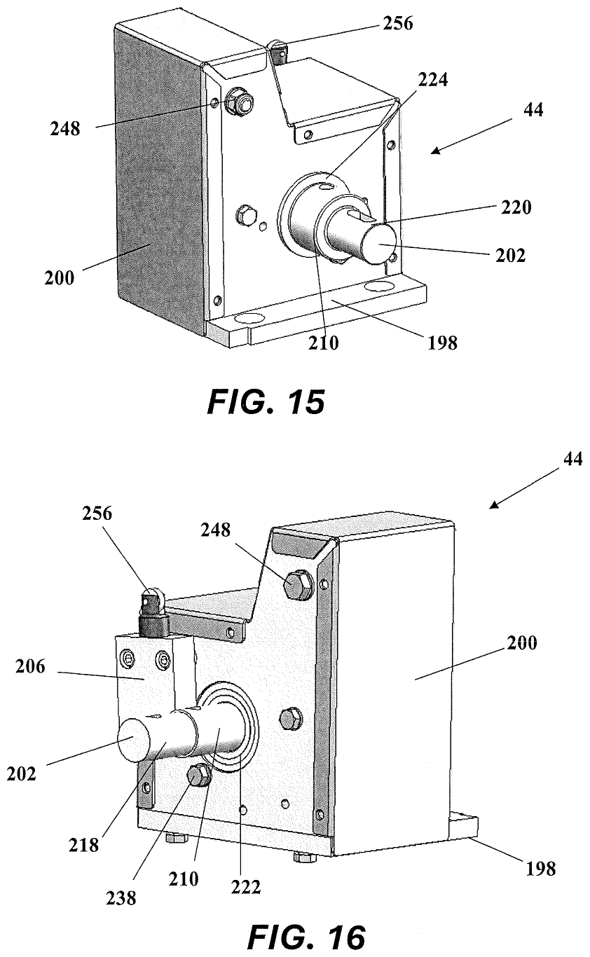

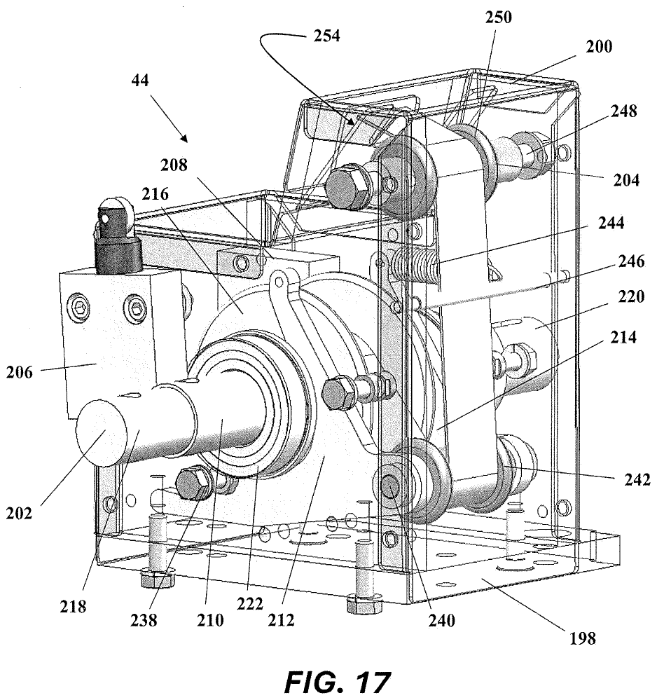

Spool assembly 44 is depicted in FIGS. 15-21, and generally includes base plate 198, housing 200, shaft assembly 202, drive strap guide assembly 204, slide upper limit switch 206, and strap tension switch 208. Shaft assembly 202 generally includes shaft 210, tension plates 212, 214, strap spool 216, output adapter 218, and input adapter 220. Shaft 210 may be a hollow tube, and rotates freely in bearings 222, 224, carried by housing 200. Strap spool 216, output adapter 218, and input adapter 220, are fixed to shaft 210 and rotate with it. As depicted in FIG. 19, tension plates 212, 214, have body 226 defining apertures 228, 230, and present tension arm 232 defining aperture 234 and tail portion 236. Tension plate axle 238 is carried by housing 200 and extends through apertures 230 of tension plates 212, 214, such that tension plates 212, 214 are rotatable on tension plate axle 238. Tension roller axle 240 is received through apertures 228 of tension plates 212, 214, and rotatably carries tension roller 242. Tension spring 244 is hooked into aperture 234 of tension arm 232, and over tension spring brace 246 which is carried by housing 200.

Drive strap guide assembly 204 generally includes axle 248 which is carried by housing 200, and roller 250.

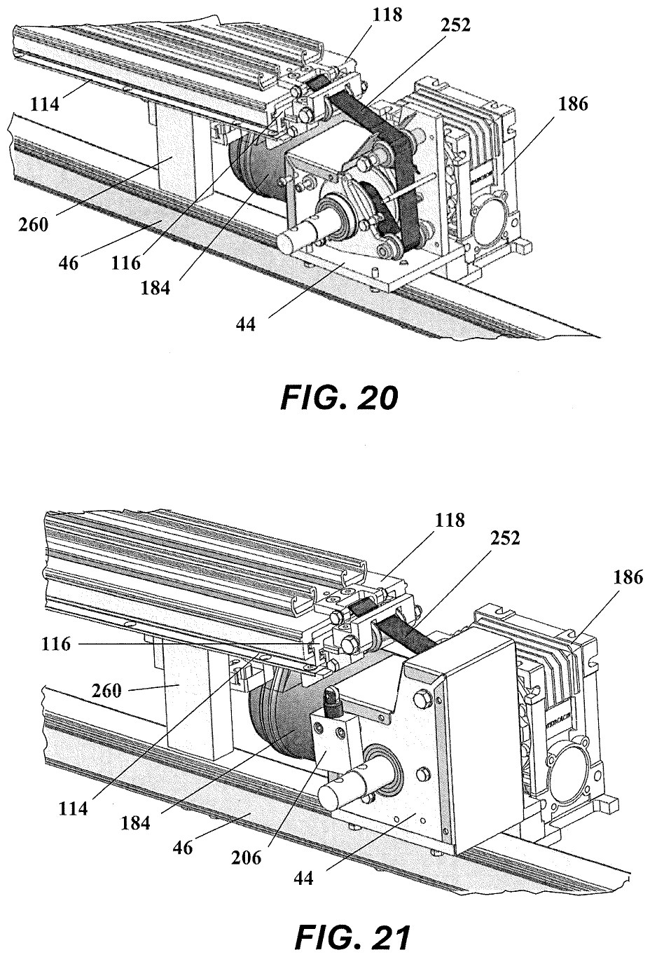

Strap 252 winds around and is rolled up on strap spool 216, over tension roller 242 and roller 250 and exits housing 200 through aperture 254. As depicted in FIGS. 20 and 21, strap 252 continues over roller 162 and attaches to strap attachment pin 168, which is coupled to third stage slide member 118.

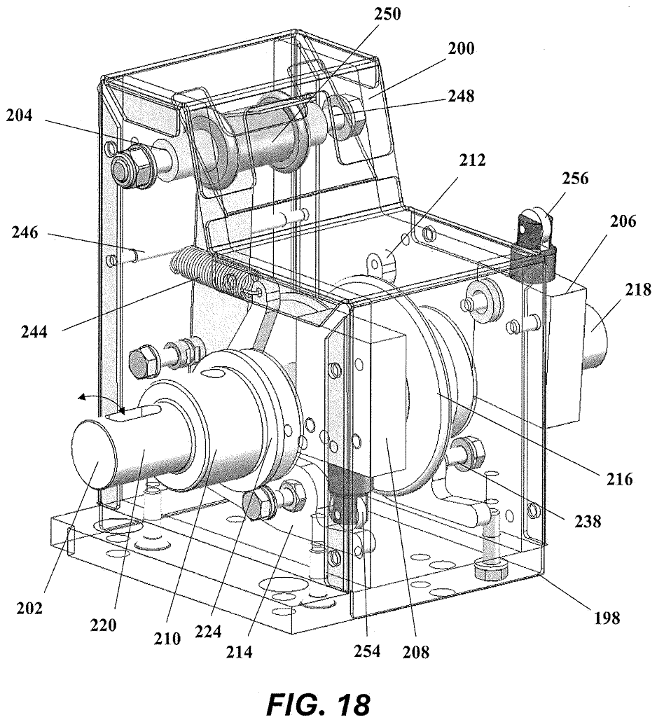

Adapter 196 of drive assembly 42 is coupled to input adapter 220 so that shaft 210 and strap spool 216 are rotated when drive assembly 42 is actuated. Viewed from the input side as in FIG. 18, clockwise rotation results in strap 252 being taken up onto strap spool 216 and counterclockwise rotation results in strap 252 being paid out from strap spool 216.

In use, slide assembly 40 begins in the fully retracted position depicted in FIGS. 1 and 2. Drive assembly 42 can be activated to turn counterclockwise, enabling strap 252 to be paid out from strap spool 216. Gas spring 78 urges first stage slide member 114, second stage slide member 116, and third stage slide member 118 to shift longitudinally along slide guide 48 through strap 183, keeping tension on strap 252 as it pays out.

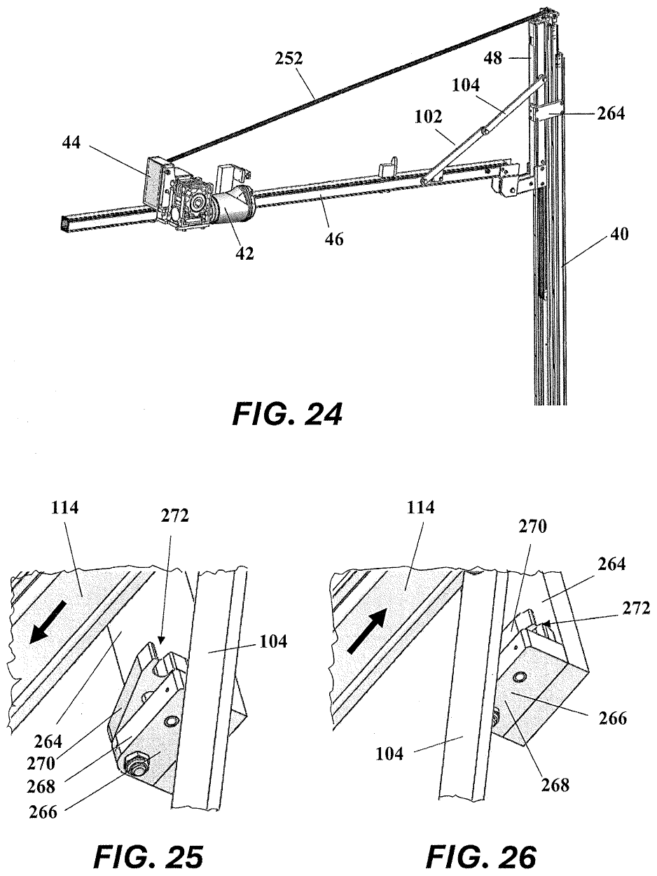

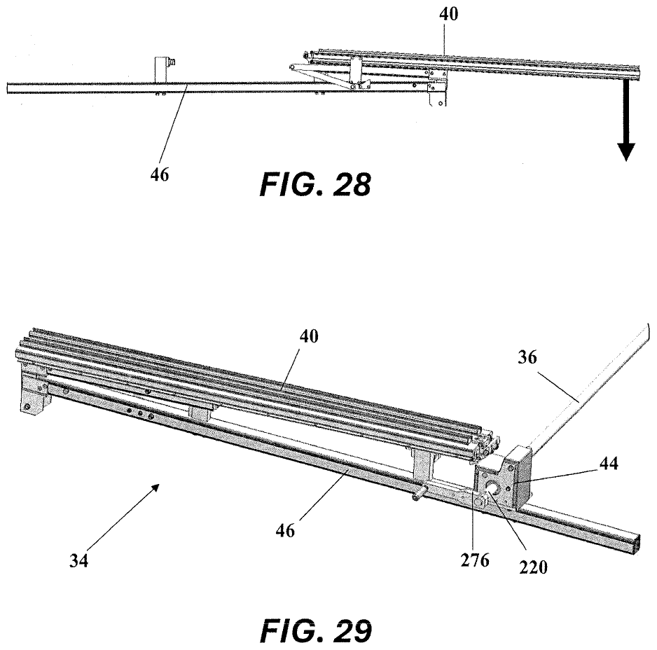

As depicted in FIG. 28, when stop blocks 152 of first stage slide member 114 contact proximal end 182 of slide guide 48, slide assembly 40 reaches a tipping point due to the weight of slide assembly 40 extending past slide guide 48. At this point, slide guide 48 and slide assembly 40 will pivot to a vertical position as depicted in FIGS. 3, 6, 6A and 24 through hinge member 66, urged by tilt gas spring 90. Second stage slide member 116 and third stage slide member 118 will then slide to their fully extended positions due to gravity as strap 252 is paid out further.

As slide guide 48 tilts, articulating stabilizer 100 unfolds and comes to its fully unfolded position, with the joint between lower arm 102 and upper arm 104 slightly over-center. When extended, articulating stabilizer 100 serves to inhibit undesired oscillation of slide assembly 40 as it is extended and travels downward.

If, for some reason, slide assembly 40 is blocked in its travel, for example if one of the slide stages becomes stuck, strap 252 will lose tension. In this case, tension spring 244 will pull tension plates 212, 214, causing them to rotate about tension plate axle 238. Tail portion 236 moves upward, contacting roller 254 of strap tension switch 208, depressing the switch and removing power from drive assembly 42.

When it is desired to return automated roof rack 30 to the stowed position, drive assembly 42 can be activated to turn clockwise. Third stage slide member 118 is pulled up by strap 252, sliding on second stage slide member 116 until stops (not depicted) on the underside of third stage slide member 118 and top side of second stage slide engage. Second stage slide member 116 then slides on first stage slide member 114 until stops (not depicted) on the underside of second stage slide member 116 and top side of first stage slide member 114 engage. First stage slide member 114, second stage slide member 116, and third stage slide member 118 are then pulled over slide guide 48 toward spool assembly 44 until limit ramp 154 contacts roller 256 of slide upper limit switch 206, depressing it and stopping drive assembly 42.

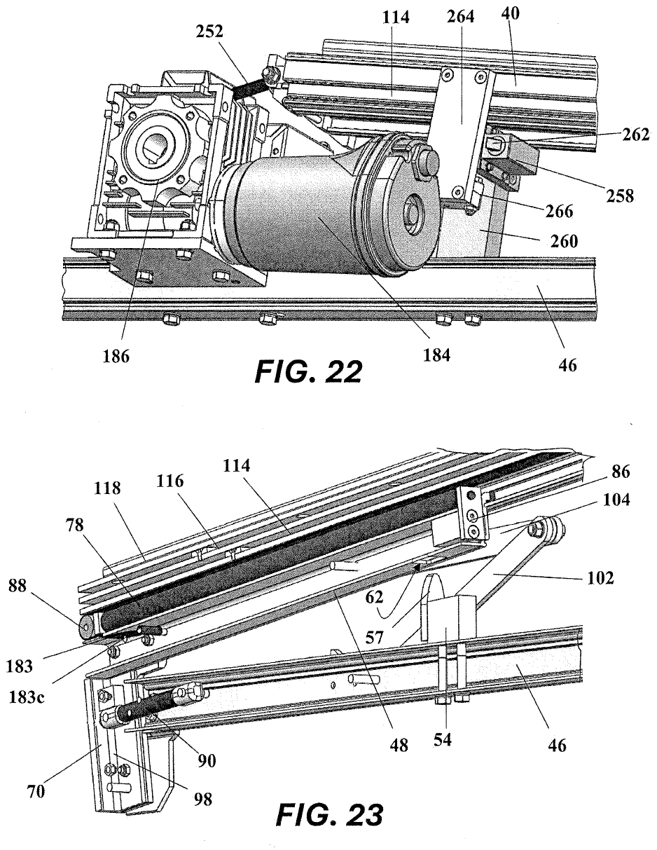

For stability and security, aligning member 57 of slide rest 54 engages in locating aperture 62 of slide guide 48. The rounded upper edge of aligning member 57 interacts with the edges of aperture 62 to align slide guide 48 with base member 46 and inhibit any side-to-side movement of slide guide 48 relative to base member 46 due to road shocks or other contact. Also, as depicted in FIGS. 22, slide assembly 40 is latched into the stowed position with electro-mechanical latch 258, which is mounted to latch tower 260, which is in turn mounted to base member 46. Latch tongue 262 extends to prevent slide assembly 40 from sliding toward the extended position by engaging bracket 264 which is attached to first stage slide member 114. When slide assembly is to be deployed, electro-mechanical latch 258 can be actuated to retract latch tongue 262 when drive assembly 42 is actuated.

Bracket 264 also carries folding mechanism 266 as depicted in FIGS. 22, 24, 25, and 26. Folding mechanism 266 generally includes base 268 and spring loaded arm 270, which defines notch 272. Folding mechanism 266 is provided to ensure that articulating stabilizer 100 folds when slide assembly 40 is retracted to the stowed position. When slide assembly 40 is deployed to the vertical position as described above, articulating stabilizer 100 unfolds. As bracket 264 and folding mechanism 266 move with first stage slide member 114, upper arm 104 contacts ramp portion 274 of spring loaded arm 270, causing spring loaded arm 270 to be depressed so that folding mechanism 266 can pass by. When slide assembly 40 is retracted, notch 272 engages upper arm 104 as first stage slide member 114 moves upward, causing articulating stabilizer 100 to be folded.

Slave hoist assembly 34 is essentially identical to driven hoist assembly 32 described above, except that drive assembly 42 is omitted, and instead, drive shaft 36 is coupled between output adapter 218 of spool assembly 44 of driven hoist assembly 32 and input adapter 220 of spool assembly 44 of slave hoist assembly 34. Hence, slave hoist assembly 34 is driven in unison with driven hoist assembly 32 and operates the same way. An additional feature of slave hoist assembly 34 is depicted in FIG. 29. In the event that drive assembly 42 is inoperative, a hand crank 276 can be connected to output adapter 220 of spool assembly 44 of slave hoist assembly 34 to enable slave hoist assembly 34 and driven hoist assembly 32 to be cranked up and down by hand.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

What is claimed is:

1. A motorized storage rack adapted to attach to a roof of a vehicle, the storage rack comprising:
a pair of spaced-apart hoist assemblies, each hoist assembly comprising:
a vehicle attachment assembly including an elongate base member adapted to attach to the vehicle, and a slide guide member operably coupled to the base member;
a slide assembly including a plurality of slide stage members, the slide assembly operably coupled to and slidably shiftable on the slide guide member, each one of the plurality of slide stage members presenting a length dimension and being operably coupled to an adjacent one of the plurality of slide stage members so as to be shiftable along the length of the adjacent one of the plurality of slide stage members so that the slide assembly is selectively extendable and retractable between a retracted position in which the slide assembly presents a first length dimension and an extended position in which the slide assembly presents a second length dimension greater than the first length dimension; and
a gas spring;
a pair of spool assemblies, each one of the pair of spool assemblies operably coupled to a separate one of the hoist assemblies and including a rotatable spool and a strap wound on the spool, the strap operably coupled with each one of the plurality of slide stage members and the gas spring, wherein the gas spring is arranged to bias the slide assembly toward the extended position by applying tension to the strap, the strap coupled to the slide stage members so as to enable progressive extension or retraction of the slide assembly depending on a direction of rotation of the spool:
a drive shaft rotatably coupling the spools of the pair of spool assemblies together; and
a drive assembly operably coupled to the spool of one of the spool assemblies and selectively operable to rotate the spool.

2. The storage rack of claim 1, wherein the drive assembly comprises an electric motor and a reduction gear box.

3. The storage rack of claim 1, wherein the slide guide member is coupled to the base member with a hinge enabling the slide guide member to be shifted between a folded position in which the slide guide member is generally parallel to the elongate base member, and an unfolded position in which the slide guide member is generally perpendicular to the elongate base member.

4. The storage rack of claim 3, further comprising an articulating stabilizer operably coupling the slide guide member and the base member.

5. The storage rack of claim 3, further comprising a gas cylinder arranged to bias the hinge toward the unfolded position.

6. The storage rack of claim 1, wherein each slide assembly has three slide stage members.

7. The storage rack of claim 6, wherein the three slide stage members include a first slide stage member, a second slide stage member, and a third slide stage member, the first slide stage member being slidably engaged with the slide guide member, the second slide stage member being slidably engaged with the first slide stage member, and the third slide stage member being slidably engaged with the second slide stage member.

8. The storage rack of claim 1, wherein an uppermost one of the plurality of slide stage members presents a top surface, the top surface having a flexible track adapted for attaching a ladder.

9. The storage rack of claim 1, wherein the gas spring has a stroke length and the gas spring and the slide stage members are coupled with the strap so that the slide stage members shift a distance of two times the stroke length when the gas spring extends.

10. A motorized rack for temporarily attaching equipment to a vehicle, the rack comprising:
at least one hoist assembly comprising:
a vehicle attachment assembly including an elongate base member adapted to attach to the vehicle, and a slide guide member operably coupled to the base member with a hinge such that the slide guide member is shiftable between a folded position and an unfolded position, the vehicle attachment assembly further including a first gas spring arranged to bias the slide guide member toward the unfolded position;
a slide assembly including a plurality of slide stage members coupled together, the slide assembly selectively extendable and retractable between a retracted position presenting a first length dimension and an extended position presenting a second length dimension, the second length dimension greater than the first length dimension, the slide assembly being shiftable on the slide guide member; and
a second gas spring;
a first spool assembly operably coupled to the at least one hoist assembly, the first spool assembly including a rotatable spool and a strap wound on the spool, the strap operably coupled with each one of the plurality of slide stage members and the second gas spring, wherein the second gas spring is arranged to bias the slide assembly toward the extended position by applying tension to the strap, the strap coupled to the slide stages so as to enable progressive extension or retraction of the slide assembly depending on a direction of rotation of the spool; and
a drive assembly operably coupled to the spool and selectively operable to rotate the spool.

11. The motorized rack of claim 10, wherein the drive assembly comprises an electric motor and a reduction gear box.

12. The motorized rack of claim 10, further comprising an articulating stabilizer operably coupling the slide guide member and the base member.

13. The motorized rack of claim 10, wherein the slide assembly has three slide stage members.

14. The motorized rack of claim 13, wherein the three slide stage members include a first slide stage member, a second slide stage member, and a third slide stage member, the first slide stage member being slidably engaged with the slide guide member, the second slide stage member being slidably engaged with the first slide stage member, and the third slide stage member being slidably engaged with the second slide stage member.

15. The motorized rack of claim 10, wherein an uppermost one of the plurality of slide stage members presents a top surface, the top surface having a flexible track adapted for attaching the equipment.

16. The motorized rack of claim 10, wherein the second gas spring has a stroke length and the second gas spring and the slide stage members are coupled with the strap so that the slide stage members shift a distance of two times the stroke length when the second gas spring extends.

17. The motorized rack of claim 10, further comprising a second hoist assembly and a second spool assembly, the second spool assembly coupled to the first spool assembly with a drive shaft.
